(19) United States
(12) Patent Application Publication
(10) Pub. No.: US 2012/0015194 A1
(43) Pub. Date: Jan. 19, 2012

(54) Method For Producing Carbonitrides by Means of a Polycondensation or Sol-Gel Method Using Hydrogen-Free Isocyanates

(76) Inventors: Carsten Ludwig Schmidt, Saarbrucken (DE); Martin Jansen, Leonberg (DE)

(21) Appl. No.: 13/144,964

(22) PCT Filed: Jan. 19, 2010
(86) PCT No.: PCT/EP10/50574

§ 371 Date: Sep. 29, 2011

(30) Foreign Application Priority Data
Jan. 19, 2009 (DE) 10 2009 005 095.7

(51) Int. Cl. B32B 17/06; B32B 9/04; B32B 15/04; C01B 21/082; C09D 1/00

(52) U.S. Cl. 428/426; 423/384; 106/287.3; 428/457; 428/454

(57) ABSTRACT

The present invention relates to a method for producing hydrogen-free carbon nitrides, in particular carbon nitrides of the stoichiometry C₃N₄. The carbon nitrides are synthesized using hydrogen-free reactants, namely inorganic isocyanates that release only CO₂ when thermally treated. In particular, a way of cheaply and efficiently providing carbonitrides, advantageously in the form of powders or coatings, is proposed.

The present invention relates to a process for the preparation of hydrogen-free carbon nitrides, in particular carbon nitrides of C₃N₄ stoichiometry. The synthesis is carried out using hydrogen-free starting materials, namely inorganic isocyanates, which release only CO₂ on heat treatment. In particular, a method is proposed for preparing carbonitrides inexpensively and efficiently, advantageously in the form of powders or coatings.

### PRIOR ART

Research into carbon nitrides, also called carbonitrides, is a modern theme of inorganic materials research. It has been studied scientifically since 1906. Since the comprehensive works of Franklin beginning in 1922, it has been ensured that only a heterogeneous C—N—H polymer can ultimately be obtained in the ternary system C—N—H or in the quaternary system C—N—O—H, which polymer is known as the polyamine with the trivial name “melon”. As a result of studies by Franklin, Takimoto, Finkelstein and Komatsu, it is well known that almost any hydrogen-containing starting material ultimately leads to melon via derivatives of the parent substance melamine, melem and melam. The many chemical paths are sufficiently well documented.

Motivated by numerous theoretical works, there has been no lack of attempts to prepare a carbonitride of C₃N₄ stoichiometry by further thermolysis of melon. This carbonitride is said to have excellent mechanical properties. All the routes followed led to date to more or less non-uniform product mixtures which contained, in addition to C and N, also heteroelements such as halides, silicon, oxygen, sulfur, alkali metals and, in particular, hydrogen. In addition to polymeric melon (C—N—H polymer), hydrogenated carbon (C—H polymer), azulmic acid (C—N—H polymer) and cyamelide (C—N—O—H polymer) are formed. All types of impurities in fact have a disadvantageous effect in the notoriously unstable C—N polymers. For example, Li⁺ and Cl⁻ can be intercalated, Si catalyses graphitisation, S is incorporated into the network, etc. The presence of hydrogen in particular is to be addressed as a main obstacle to the preparation of a pure, reproducible and defined carbonitride.

While only gaseous N₂ and (CN)₂, which counteract a desired stoichiometry, can form in the binary system C—N, the readily volatile compounds HCN, NH₃, CH₄ and H₂NCN are already additionally present in the ternary system C—N—H. Much space is accordingly given to the decomposition of a homogeneous C—N network with defined stoichiometry. In fact, it has long been known that the simultaneous presence of nitrogen and hydrogen in a carbon-based network/polymer yields pure carbon very easily and efficiently (purifier effect). Use is made of this circumstance in the synthesis of high-quality graphite.

The relationships in the quaternary system C—N—O—H are even less clear. Studies of systems such as C—N—S and C—N—S—H (e.g. NH₄SCN) did not bring any conclusive advantages either. On the contrary, sulfur is stubbornly retained and can be detected in relatively large amounts in the polymeric product (Franklin et al., Purdy et al.). This is due in particular to the fact that there appears to be no marked impetus to form elemental S or CS₂. It is clear from the explanations that hydrogen and all other impurities must be excluded as far as possible. In fact, it can be assumed, according to the state of knowledge, that the absence of hydrogen is to be considered an essential requirement for the successful synthesis of a pure C₃N₄.

Compounds in the binary system C-N have been prepared with the aid of very complex physical methods. These include microwave and radio wave syntheses, gas phase depositions, plasma processes and reactive sputtering. A common feature of all the methods is the very complex procedure, combined with high costs and a low throughput. According to the prior art, it appears very unlikely that it will be possible to provide a marketable process on this basis. In addition, the mentioned processes are not subject to any chemical control and thus often lead to results which are not reproducible or are even contradictory. Owing to the complex nature of the processes, various impurities are often formed, which stand in the way of successful synthesis. In fact, the synthesis of a phase-pure C₃N₄ (demonstrated by elemental analysis) has not been possible by any of these approaches.

Chemical synthesis methods aimed at producing a hydrogen-free C₃N₄ are repeatedly being proposed. The fundamental idea here is to specify a suitable stoichiometry by choosing a suitable (molecular) precursor/starting material and conserve it into the desired product. These approaches, all of which function on the basis of triazine, remained without demonstrable success, however.

For example, a method has been proposed in U.S. Pat. No. 5,606,056 (1997) for preparing a C₃N₄ starting from substituted triazines by suitable inter- and intra-molecular decomposition reactions. However, only extremely thin films (up to 400 nm) which cannot be fully characterised are actually obtained. Furthermore, the proposed CVD process does not proceed as desired; volatile product mixtures which should or must not occur according to the theory are explicitly obtained. In addition, a band is observed at 3200 cm⁻¹ in the IR, which very clearly indicates OH groups. Accordingly, a hydrogen-containing sample is clearly present. The preparation of powders is not achievable by this route. Owing to the small layer thicknesses, no mechanical protection is to be expected.

In DE patent 197 06 028 (1998), halotriazines are reacted with substituted carbodiimides. In this case too, hydrogen-containing samples are obtained, which can be demonstrated by means of elemental analysis or IR spectroscopy (bands at 3130 cm⁻¹ and 3077 cm⁻¹). Furthermore, the complete absence of halogens or silicon is not ensured. In addition, the product is sensitive to moisture, which cannot be reconciled with pure C₃N₄. Finally, only powders are obtained by this route; coatings are not obtainable.

U.S. Pat. No. 6,428,762 (2002) proposes the synthesis of C₃N₄ starting from halotriazines and alkali metal nitrides. Hydrogen-containing (elemental analysis and IR) pulverulent specimens are obtained. In addition, the presence of graphitic carbon is clearly demonstrated by Raman spectroscopy, so that it must be assumed in this case that the product is impure and partially decomposed. The density of the samples is surprisingly low (1.34-1.38 g/cm³) and the use of these preparations to produce hard materials is questionable. Finally, coatings are not possible in this case either.

DE patent 102005014590 (2006) likewise proposes a process based on the decomposition of a substituted triazine. In this case too, impure products are present. Undesirable halide impurities are found; IR spectroscopy shows clear and marked broad bands between 3000 cm⁻¹ and 3700 cm⁻¹. Accordingly, the preparations must be said to be hydrogen-containing in this case too.

In WO 2006/087411 (2006) it is proposed to decompose alkali metal rhodanides in order to prepare carbonitrides. The proposed process was published as early as 1998 by Purdy et al., and the speculations described in the patent clearly contradict the results of Purdy et al. WO 2006/087411 does not itself disclose any measurements which rebut the statements made by Purdy et al. In any case, the unknown alkali metal salts must be washed out with water or protic solvents. This leads according to the prior art to detectable OH or NH functional groups in the preparation. The production of coatings is also scarcely achievable with this process.

Accordingly, it is an object of the invention to prepare hydrogen-free carbon nitrides.

The stated object has been achieved by a process for the preparation of a carbon nitride, comprising the steps (i) providing a hydrogen-free, inorganic isocyanate and (ii) heat treatment of the hydrogen-free, inorganic isocyanate, the isocyanate being converted by CO₂ abstraction into a carbon nitride.

According to the invention, a process for the preparation of a hydrogen-free carbon nitride is provided. By means of the process according to the invention it is possible in particular to obtain a carbon nitride which has a hydrogen content, based on the total weight of the carbon nitride, of <1% by weight, more preferably <0.1% by weight, yet more preferably <0.01% by weight. In particular, a carbon nitride which is completely hydrogen-free is prepared.

A hydrogen-free carbon nitride of this type is obtained according to the invention by using a hydrogen-free inorganic isocyanate as starting material. Furthermore, it has been found according to the invention that hydrogen-free inorganic isocyanates of this type are converted into a carbon nitride by heat treatment with CO₂ abstraction. The absence of hydrogen in the product is thus ensured according to the invention by the use of hydrogen-free starting materials.

The heat treatment preferably takes place under protecting gas, for example under argon or nitrogen. Only CO₂ is released thereby. The heat treatment takes place preferably at a temperature of up to 500° C., more preferably up to 470° C., yet more preferably up to 450° C. For the reaction, the starting material is treated preferably at a temperature of at least 200° C., more preferably at least 300° C. and yet more preferably at least 400° C.

By means of the process according to the invention a carbon nitride is prepared, in particular a carbon nitride of the formula CN_{N}, wherein x=from 0.1 to 1.33. A carbon nitride of this type is a dense, three-dimensionally highly crosslinked inorganic macromolecule which is preferably in the form of a powder or of a coating. Preferably, the carbon nitride is composed only of the atoms C and N. The resulting carbon nitride has a stoichiometry preferably in the range of x=from 0.5 to 1.33, more preferably x=from 1 to 1.33. Most preferably, CN_{1.33} stoichiometry is present (which corresponds to C₃N₄).

By means of the process according to the invention it is possible to prepare carbon nitride in large amounts, for example in amounts of from 0.1 to 1 g, by simple reaction sequences. It is, however, also possible to form the carbon nitride in the form of a coating or of a film, in particular on suitable substrates.

Particularly preferably, pure, inorganic isocyanates are polycondensed at relatively high temperatures under protecting gas (e.g. argon or nitrogen). Only CO₂ is released thereby.

During the reaction sequence, the batch is preferably cooled and comminuted, for example ground, at specific intervals, for example every 6 hours to 10 hours, in particular every 8 hours, in order to ensure that the reaction is as complete as possible. The total duration of the polycondensation is from 8 to 24 hours. Under normal pressure (p=1 atm), the condensation can be carried out up to a temperature of 500° C. Preference is given to a maximum of 475° C. and particularly preferably a maximum of 450° C. Higher temperatures require the use of high-pressure conditions (p>1 atm).

The polycondensation can optionally also or simultaneously be carried out in suitable solvents or dispersing agents, for example liquid solvents with a high boiling point (preferably having a boiling point >130° C.), ionic liquids, molten salts, etc. This is not preferred, however. In addition, the polycondensation can be carried out under reduced pressure. However, this is also not preferred.

The heat treatment takes place according to the invention in the presence of a catalytic amount of mercury. Particularly preferably, the heat treatment takes place with contact with mercury under a protecting gas atmosphere.

A preferred form of the reaction is the reaction of the pure, solid isocyanates with mercury (Hg) contact in an atmosphere of dry nitrogen in a closed vessel (autoclave, glass ampoule, etc.).

A further preferred embodiment consists in dispersing the isocyanate in an organic solvent, in particular in a polar aprotic solvent. Diethyl ether or acetonitrile are particularly preferably used as solvent. After stirring for a few minutes, a viscous sol which is suitable for coatings is obtained. After the coating, the solvent is evaporated off and the deposited inorganic macromolecule is densified, in particular under protecting gas, such as, for example, N₂.

Suitable isocyanate-based starting materials are in particular all explicitly hydrogen-free representatives from which a solid of the empirical formula “C₃N₄” is obtained by CO₂ abstraction. They include, for example, molecular, monomeric isocyanates, such as, for example, cyanogen isocyanate, triisocyanate-s-triazine or oligomers (associates) resulting therefrom, as well as macromolecular polyisocyanates (C₂N₂O)ₓ or [(C₃N₃)(NCO)₃]ₓ, wherein x is an integer from 1 to 500, in particular from 3 to 100, preferably from 5 to 50 and most preferably from 10 to 40. The use of polyisocyanates is preferred, and the use of polymeric (C₂N₂O)ₓ is particularly preferred. The starting materials are known to be sensitive to moisture and are accordingly handled under protecting gas conditions. The methods for preparing and safeguarding as well as working with suitable protecting gases are known to the person skilled in the art.

(C₂N₂O)ₓ can be prepared by several methods. These include, for example, the reaction of XCN (X=F, CI, Br, I) with elemental isocyanates E(NCO)ₓ. Suitable elements therefor are, for example, Li, Na, K, Rb, Cs, Mg, Ca, Sr, Ba, B, Al, Ga, In, Si, Ge, Sn, Pb, P, Cu, Ag, Au, Zn. The isocyanates of the elements are obtainable by known metathesis reactions. The reaction of CICN with elemental isocyanates is preferred, and the reaction of CICN with AgNCO is particularly preferred. Another possibility consists in the thermal decomposition of CuNCO (copper isocyanate) or AgNCO (silver isocyanate) under vacuum conditions. The use of AgNCO is advantageous. A further possibility consists in the reaction of cyanamide with carbonylbisimidazole (Staab's reagent).

[(C₃N₃)(NCO)₃]ₓ can be prepared by reaction of C₃N₃Cl₃ (cyanuric chloride) with AgNCO, or by reaction of C₃N₃(NH₂)₃ (melamine) with oxalyl chloride or phosgene. Preference is given to the thermal decomposition of the corresponding acyl azide via thermally induced Lossen rearrangement.

Other known methods for preparing isocyanates are known to the person skilled in the art and can likewise be used.

The (polymeric) isocyanates thus prepared are moisture-sensitive compounds. They can be clearly characterised by means of IR, UV, MS, NMR and elemental analysis. Elemental analysis and IR spectroscopy are particularly informative. In IR, characteristic bands can be found at 2288 cm⁻¹, 2342 cm⁻¹, 1793 cm⁻¹ and 1382 cm⁻¹ in the case of C₂N₂O. The required absence of hydrogen is verified by the complete absence of the N—H, O—H or C—H bands. The elemental analysis for C₂N₂O gives the following values [calculated]:C:35.47% by weight [35.31], N:41.51% by weight [41.18], 0:19.30% by weight [23.52]. The formula C₂N₂O_{0.9} is obtained. No impurities are detectable. This is also supported by comparative Rutherford backscattering experiments.

The colourless or yellowish compounds begin to release only CO₂ from T>100° C. This exothermic reaction can be monitored by means of TG, DSC or DTA-MS. Other decomposition products do not occur. This polycondensation is well known in organic chemistry and serves to prepare analogous carbodiimides according to

2 R—NCO→R—NCN—R+CO₂.

At higher temperatures, most known polycarbodiimides decompose with the release of HCN, (CN)₂, N₂ or NH₃. Free (graphitic) carbon is finally obtained. The preferred thermal process of this invention consists in ensuring a CO₂ abstraction which ideally proceeds to completion, while simultaneously suppressing the thermal fragmentation of the resulting carbonitride.

To that end, the isocyanate starting material, for example the yellow powder (C₂N₂O)ₓ, is advantageously introduced into a reaction chamber, for example into a heated glass ampoule, which is melted under protecting gas, for example nitrogen. A gas-tight reaction chamber is accordingly present. A steel autoclave can likewise advantageously be used. The closed conditions prevent the sublimation of lower oligomers of the polyisocyanate and accordingly a change in the overall stoichiometry. Because the CO₂ that forms cannot be dissipated efficiently, it is necessary to interrupt the thermolysis at least once, open the reaction chamber and allow the CO₂ to escape. The solid is then homogenised mechanically and again subjected to thermolysis under protecting gas, for example under N₂, in the closed system. The polycondensation is preferably interrupted twice. Particularly preferably three times. The reaction, which is carried out at a maximum of 500° C., is complete after 24 hours at the latest. The density of the resulting C₃N₄ is from 2.0 g/cm³ to 2.3 g/cm³, in particular 2.0 g/cm³.

In a preferred variation of the process, a catalytic amount of elemental mercury, for example a drop of elemental mercury, is also added to the isocyanate, in particular to the polyisocyanate (C₂N₂O)ₓ, and the thermolysis is carried out in the described manner. After the reaction, the drop is removed mechanically and the powder is heated at from 150° C. to 250° C., in particular at 200° C., in vacuo. No further Hg contamination is then detectable by means of XRD and EDX. The density is from 2.0 g/cm³ to 2.3 g/cm³, in particular 2.3 g/cm³.

The carbon nitride obtainable according to the invention accordingly has a density preferably of at least 2.0 g/cm³, more preferably of at least 2.1 g/cm³, yet more preferably of at least 2.2 g/cm³ and most preferably of at least 2.3 g/cm³.

It has been shown that this contact process yields a network of a higher density than a polycondensation without Hg. This densification, which has hitherto been observed only in the case of elemental phosphorus, surprisingly yields a similar advantageous effect in the case of C₃N₄. This was not deducible from the current state of knowledge because there is no obvious chemical analogy between elemental, crystalline phosphorus and the amorphous, binary compound C₃N₄. Without being bound to any theories, it can be supposed that the metallic surface of the Hg is capable of entering into resonance with the electrons of the chemical bonding system of the inorganic macromolecule. This permits electron or bond formations as well as rearrangement reactions which contribute to an efficient three-dimensional linkage. Networks of high density (efficient linkage) are an essential prerequisite for the preparation of crystalline variants of C₃N₄ by means of high-pressure techniques. However, the known amorphous C-N networks in fact have a density <2.0 g/cm³. The route according to the invention thus represents a significant improvement in the synthesis of amorphous C—N networks.

In an alternative embodiment, the inorganic isocyanate is dispersed in a solvent of suitable polarity. This is preferably effected by polymerisation of molecular isocyanates which oligomerise in suitable solvents and optionally form lyophilic colloids. Aprotic, polar solvents with suitable vapour pressure, such as, for example, diethyl ether or acetonitrile, are preferably used. It is also possible to use solvent mixtures. The advantageous effect of solvent mixtures on the quality of a coating is known to the person skilled in the art and does not require further explanation. The optionally colloidal structures in solution, that is to say the sol, age further at room temperature, so that the viscosity of the solution increases constantly, which can be monitored rheologically. The colour thereby changes from yellow to orange. At a suitable viscosity (close to the gel point), the sol becomes stringy and can be used to coat substrates. On further ageing, the solution solidifies to an orange-coloured gel. After several days, syneresis is observed. The low-solvent dark-orange gel separates from the colourless solvent. The gel is so efficiently crosslinked and the capillary system is so small that solvent can even be enclosed in the gel, that is to say the solvent is unable to penetrate the gel. Such a process is also referred to as the sol-gel process.

The coating can be applied to substrates by known processes, for example either by spraying, dipping or spin coating. Application by brushing is also possible. Suitable substrates are, for example, glasses and ceramics as well as metals.

The layers dried, for example, at room temperature form a closed dense coating of the polymeric xerogel. IR spectroscopy of the xerogels teaches that solvent is still present at room temperature. Removal of the solvent and the onset of polycondensation are reactions which proceed in parallel and guarantee the homogeneity of the deposited film or prevent the occurrence of “chalking effects”.

The resulting brown powder is not noticeably sensitive to hydrolysis. The compound is an electrical insulator. EPR spectroscopy indicates the presence of paramagnetic centres on the carbon atoms (g=2.0039). A scanning electron microscope image shows the presence of an amorphous network with a macroporous structure. Elemental analysis gives the following values: [calculated for C₃N₄]:C:39.06% by weight [39.14% by weight], N:59.21% by weight [60.86% by weight], O:1.73% by weight [0.0% by weight].

In IR, no bands are to be seen at wave numbers >3000 cm⁻¹, that is to say the carbonitride is hydrogen-free. Bands can be found between 1650 and 1250 cm⁻¹, as well as a sharp band at 811 cm⁻¹. Wholly surprisingly, the spectroscopy shows clearly and unambiguously that no inorganic polycarbodiimides are formed. The inorganic isocyanates do not show the same course of reaction as the organic representatives. This special behaviour of the inorganic polyisocyanates was not deducible from the state of knowledge, and the reaction path according to the invention does not yield detectable carbodiimides or cyanamides. Rather, the surprising fact arises that triazine or hepazine structures are formed by this route, which is indicated in particular by the band at 811 cm⁻¹. This surprising reaction path permits comparatively thermally stable C—N networks. It is known from organic chemistry that polycarbodiimides can already decompose from 250° C.

The carbon nitride obtainable according to the invention preferably consists solely of C and N and is in particular free of H, Hal (e.g. F, Cl, Br, I), Si, O, S and alkali metals. The carbon nitride contains in particular less than 2% by weight, especially less than 1% by weight, preferably less than 0.1% by weight, of each of those elements, based on the total weight.

It has now been found, wholly surprisingly, that a definitively hydrogen-free, in particular homogeneous C—N network has a significantly lower thermal stability than a hydrogen-containing network. While thermolyses in the system C—N—H, which proceed via the known stages melem, melam and melon, are carried out up to temperatures of 600° C., that is apparently not possible in the system C—N. A hydrogen-free C₃N₄ begins to decompose slowly from 450° C. Although a standard DTA (heating rate 10 K/min) on a C₃N₄ according to the invention feigns stability to 600° C., it has been shown by closer studies that C₃N₄ loses 4.8% of its mass within 11 hours at 500° C. The loss of mass increases dramatically at higher temperature. For example, 25% has already decomposed after 11 hours at 550° C., even 85% at 600° C.

Because the route for the production of pure C₃N₄ that is discussed in the expert literature and most widely accepted among experts should proceed via the hydrogen-containing polyamide melon (deammonoisation), the surprising finding underlying this invention was not readily deducible. In fact, under the temperature conditions of the preparation of melon (T=600° C.), a C₃N₄ is already thermally unstable. The route according to the invention, by the use of hydrogen-free starting materials, accordingly yields a pure, hydrogen-free C—N network. Reports which wished to prepare a hydrogen-free carbonitride using hydrogen-containing starting materials all exhibit O—H or N—H bands in the IR. Furthermore, they have a temperature stability which is not comparable with that herein and is close to that of melon.

In a further aspect of the present invention it is possible, in particular in the case of coating processes, to degrade the C₃N₄ in a thermally controlled manner to a lower carbonitride CNₓ (x<1.33) or completely to carbon. This is advantageously achieved by suitable heating under N₂ at temperatures >450° C. This controlled degradation permits the preparation of different CNₓ layers (0<x<1.33). The thermal degradation preferably takes place between 500° C. and 600° C.

The carbon nitride according to the invention, in particular C₃N₄, can be converted at temperatures >475° C. in a controlled manner into a carbonitride of the form CN_{N}, wherein x <1.33, and in particular can be converted at temperatures >475° C. in a controlled manner into pure carbon.

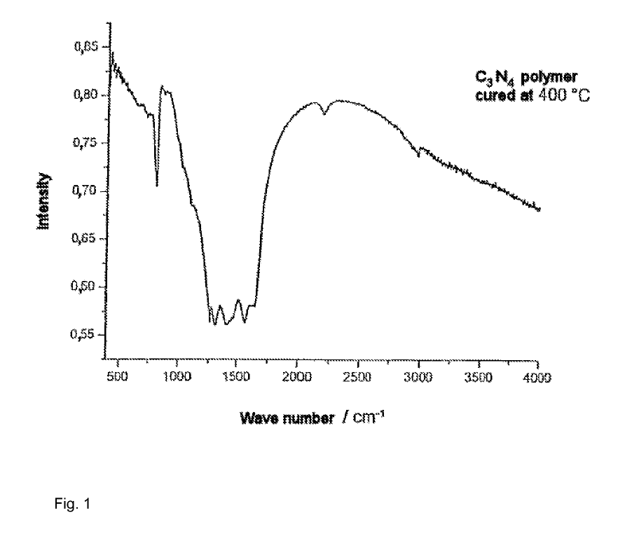

FIG. 1 shows the IR spectrum of a C₃N₄ polymer prepared according to the invention, which has been cured at 400° C.

### EXAMPLES

The following examples serve to illustrate the route according to the invention and are not to be interpreted as a limitation or preference. Changes to the processes are known to the person skilled in the art and are likewise covered by the invention.

### Preparation of the Isocyanates:

1) AgNCO is thermolysed under a dynamic vacuum (10⁻³ mbar) at 750° C. for one hour. The pyrolysis gases released are condensed in a cold trap (liquid nitrogen, T=−196° C.). Slow warming of the pyrolysis gases to room temperature yields pure, yellow-coloured, polymeric C₂N₂O.

2) Solid AgNCO is cooled (dry ice/acetone, T=−76° C.), and excess ClCN is added (ratio 1:2). The mixture is left for 12 hours at this temperature and then slowly warmed. Excess gaseous CICN escapes. A mixture of AgCl and C₂N₂O is obtained.

3) Melamine is suspended in toluene. Excess oxalyl chloride is added thereto (ratio 1:10). The mixture is boiled for 4 days under reflux. The yellow solid is isolated and washed several times with toluene. Pure C₃N₃(NCO)₃ is obtained.

4) Cyanamide is reacted with Staab's reagent (carbonylbisimidazole) (1:1) in acetonitrile. C₂N₂O suspended in acetonitrile and imidazole is obtained. The solvents are removed under a dynamic vacuum.

### Preparation and Use of the Polyisocyanate Dispersion

Colourless C₂N₂O is dispersed in acetonitrile (1 g to 10 g of solvent). A pale-yellow clear solution is obtained. The solution is concentrated slowly until an orange-coloured viscous dispersion has formed. At a suitable viscosity, the solution can be used for coating processes.

Sheets of glass (cleaned and degreased) are dipped in the solution, wetted for 30 seconds and withdrawn at a controlled speed. The film is dried at RT under protecting gas. The coating process is optionally repeated.

The substrates thus coated are heated slowly to 450° C. under flowing N₂. Brown-coloured, touch-proof coatings are obtained.

### Preparation of C₃N₄ Powders of High Density

C₂N₂O (0.5 g) is mixed with one drop of Hg and introduced into a glass ampoule. The ampoule is sealed under N₂ and heated slowly to 450° C. After 8 hours, the batch is cooled, homogenised again and subjected to heat treatment again. A brown powder is finally obtained, which is removed mechanically from the admixed Hg.

1-34. (canceled)

35. A method for preparing a carbon nitride, comprising:
(i) providing a hydrogen-free, inorganic isocyanate; and,
(ii) heating the hydrogen-free, inorganic isocyanate, wherein the hydrogen-free, inorganic isocyanate is converted by CO₂ abstraction into a carbon nitride.

36. The method of claim 35, wherein the carbon nitride is a hydrogen-free carbon nitride.

37. The method of claim 35, wherein heating the hydrogen-free, inorganic isocyanate occurs at temperatures up to 500° C.

38. The method of claim 35, wherein the carbon nitride is of the formula CN_{N}, wherein x is from 0.1 to 1.33.

39. The method of claim 35, wherein the carbon nitride is in the form of a powder or a coating.

40. The method of claim 35, wherein the hydrogen-free, inorganic isocyanate consists only of the elements C, N and O.

41. The method of claim 35, wherein the hydrogen-free, inorganic isocyanate corresponds to the empirical formula [C₂N₂O]ₓ or [C₃N₃(NCO)₃]ₓ, wherein x≧1.

42. The method of claim 35, wherein the heating occurs in a closed, gas-tight vessel.

43. The method of claim 35, wherein the heating is interrupted at least once for homogenizing the sample.

44. The method of claim 35, wherein the heating occurs in the presence of a catalytic amount of mercury.

45. The method of claim 35, wherein a hydrogen-containing component is not present in any synthesis or purification step.

46. The method of claim 35, wherein the hydrogen-free, inorganic isocyanate is dispersed in a solvent prior to heating.

47. The method of claim 35, wherein the hydrogen-free, inorganic isocyanate is dispersed in a polar aprotic solvent.

48. The method of claim 35, wherein the hydrogen-free, inorganic isocyanate is dispersed in acetonitrile.

49. Carbon nitride produced by the method of claim 35.

50. The carbon nitride of claim 49, further comprising a solvent or dispersing agent.

51. The carbon nitride of claim 49, wherein the carbon nitride is hydrogen-free.

52. The carbon nitride of claim 49, wherein the carbon nitride has a density of at least 2.0 g/cm³.

53. The carbon nitride of claim 49, wherein the carbon nitride shows no C—H, N—H or O—H bands in the IR spectrum.

54. The carbon nitride of claim 49, wherein the carbon nitride is thermally stable to a maximum of 500° C.

55. The carbon nitride of claim 49, wherein the carbon nitride shows no bands of free carbon in the Raman spectrum.

56. A starting material for the synthesis of hard materials comprising the carbon nitride of claim 49.

57. A catalyst and/or catalyst support material comprising the carbon nitride of claim 49.

58. A tribological layer comprising the carbon nitride of claim 49.

59. A protective film for protecting magnetic functional elements against corrosion and/or against damage caused by contact, comprising the carbon nitride of claim 49.

60. A coating comprising the carbon nitride of claim 50.

61. A glass, ceramic or metal comprising the coating of claim 60.

62. The coating of claim 61, wherein the coating is applied by means of a dipping, brushing, spraying, spin coating or spread-coating process.

63. The coating of claim 61, wherein the coating is thermally densified up to a temperature of 500° C. under protecting gas.

64. The coating of claim 61, wherein the coating is based on C₃N₄.
